(19) United States
(12) Patent Application Publication
(10) Pub. No.: US 2025/0369470 A1
(43) Pub. Date: Dec. 4, 2025

(54) SPLIT SHAFT COUPLING

(71) Applicant: NATIONAL OILWELL VARCO, L.P., Houston, TX (US)

(72) Inventor: Michael Davies, Stockport (GB)

(21) Appl. No.: 18/679,901

(22) Filed: May 31, 2024

(51) Int. Cl. F04C 15/00; F04C 2/107; F16D 1/04

(52) U.S. Cl. CPC F16B 7/0426; F04C 15/0061; F16D 1/04; F16D 1/0864; F04C 2/1073; F04C 2240/60; F16D 2250/0084; F16D 2300/12; Y10T 403/5766; Y10T 403/5781; Y10T 403/7067

(57) ABSTRACT

A shaft coupling for coupling a prime mover shaft to a power input shaft of a progressive cavity pump can include a first half shell and a second half shell. Each of the half shells can include a first end and a second end along a longitudinal center axis, the first end can include an inner contour which can be configured to match an outer contour of the prime mover shaft and the second end can include an inner contour which can be configured to match an outer contour of the power input shaft. The shaft coupling can include a fastening mechanism, which can be configured for applying a force on the first half shell and the second half shell that can be in a radially inward direction, where the force can be applied through the longitudinal center axis.

### CROSS-REFERENCE TO RELATED PATENT DOCUMENTS

This patent application is related to Davies et al., U.S. patent application Ser. No. ______ entitled “Seal Assembly for Progressive Cavity Pump,” (Attorney Docket No. 5233.369US1), filed on the same date as the present application, which is hereby incorporated by reference herein in its entirety.

### TECHNICAL FIELD

The present disclosure relates to power couplings, and more particularly, but not by way of limitation, to shaft couplings.

### BACKGROUND

The background description provided herein is intended to generally present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A progressive cavity pump can be a positive displacement pump and may also be referred to as an eccentric screw pump or a cavity pump. Progressive cavity pumps may include a stator with a helically shaped cavity and a helically shaped rotor arranged in the cavity of the stator. The rotor may be rotated in the stator, which may cause the transfer of fluids through a sequence of progressing cavities, which can be formed between the stator and rotor. A progressive cavity pump can include one or more shaft couplings.

Shaft couplings can be used to connect a first shaft to a second shaft. A shaft coupling can transfer torque from one shaft to another shaft. For example, a power input shaft of a progressive cavity pump can be coupled to a prime mover shaft using a shaft coupling.

In an approach, one of the prime mover shaft or the power input shaft can be configured to receive the other one of the prime mover shaft or power input shaft, and a pin passing through both shafts can be configured to transfer torque between the shafts. However, this can result in the outer shaft having an enlarged diameter to maintain a specified level of strength, the pin experiencing a large amount of sheer force, or both. In this approach, decoupling the prime mover shaft from the power input shaft can require unmounting the prime mover, the progressive cavity pump, or both, which can provide a gap between the shafts.

### SUMMARY

In an example, a shaft coupling for coupling a prime mover shaft to a power input shaft of a progressive cavity pump can include a first half shell and a second half shell. Each of the half shells can include a first end and a second end along a longitudinal center axis, the first end can include an inner contour which can be configured to match an outer contour of the prime mover shaft and the second end can include an inner contour which can be configured to match an outer contour of the power input shaft. The shaft coupling can include a fastening mechanism, which can be configured for applying a force on the first half shell and the second half shell that can be in a radially inward direction, where the force can be applied through the longitudinal center axis.

In an example, a method of coupling a prime mover shaft to a power input shaft of a progressive cavity pump can include aligning, axially and longitudinally, the prime mover shaft and the power input shaft. The method can also include placing a first half shell and a second half shell over a coupling point of the prime mover shaft and the power input shaft, each of the half shells including a first end and a second end along a longitudinal center axis, the first end including an inner contour which can be configured to match an outer contour of the prime mover shaft and the second end including an inner contour which can be configured to match an outer contour of the power input shaft. The method can also include applying a force on the first half shell and the second half shell which can be in a radially inward direction, where the force can be applied through the longitudinal center axis.

In an example, a progressive cavity pump system, can include a prime mover including a prime mover shaft. The progressive cavity pump system can also include a progressive cavity pump, including a power input shaft. The progressive cavity pump system can also include a shaft coupling for coupling the prime mover shaft to the power input shaft, the shaft coupling can include a first half shell and a second half shell, each of the half shells including a first end and a second end along a longitudinal center axis, the first end including an inner contour which can be configured to match an outer contour of the prime mover shaft and the second end including an inner contour which can be configured to match an outer contour of the power input shaft. The shaft coupling can also include a fastening mechanism, which can be configured for applying a force on the first half shell and the second half shell can be in a radially inward direction, where the force can be applied through the longitudinal center axis.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows a perspective view of an example of portions of a progressive cavity pump system.

FIG. 2 shows a side view of the progressive cavity pump system of FIG. 1.

FIG. 3 shows a cross-sectional view of the progressive cavity pump system of FIG. 1.

FIG. 4 shows a close-up cross-sectional view of a shaft coupling of the progressive cavity pump system of FIG. 1.

FIG. 5 shows a perspective view of an example of the shaft coupling of the progressive cavity pump of FIGS. 1-4.

FIG. 6 shows a top view thereof.

FIG. 7 shows a bottom view thereof.

FIG. 8 shows a perspective view of the shaft coupling of FIGS. 5-7 with the fastening mechanism removed.

FIG. 9 shows an additional perspective view thereof.

FIG. 10 shows a diagram depicting an example of a method for coupling shafts.

### DETAILED DESCRIPTION

A progressive cavity pump system can include a prime mover including a prime mover shaft and a progressive cavity pump including a power input shaft. The prime mover shaft can be coupled to the power input shaft such that the torque generated by the prime mover can be transferred to the progressive cavity pump, which can help to allow the progressive cavity pump to pump a fluid.

A shaft coupling can include a first half shell, a second half shell, and a fastening mechanism, which can apply a force that pulls the first half shell and second half shell together. The first half shell and the second half shell can at least partially surround the prime mover shaft and the power input shaft. A frictional force between the half shells and the respective shafts can transfer torque from the prime mover shaft into the half shells, and then into the power input shaft. Torque can be transferred through frictional forces, and there need not be a shear force in the fastening mechanism. In this example, there may be a longitudinal gap between the shafts. This can allow the shafts to be decoupled without unmounting the prime mover or the progressive cavity pump. Each of the shafts can be solid across their entire diameter. This can help to allow the shafts to have a maximum strength for a specified diameter.

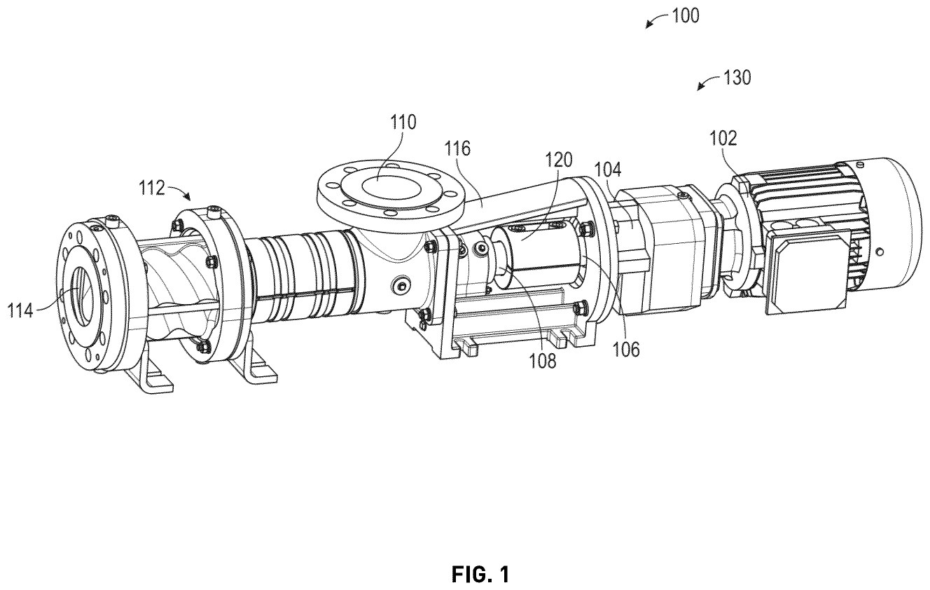

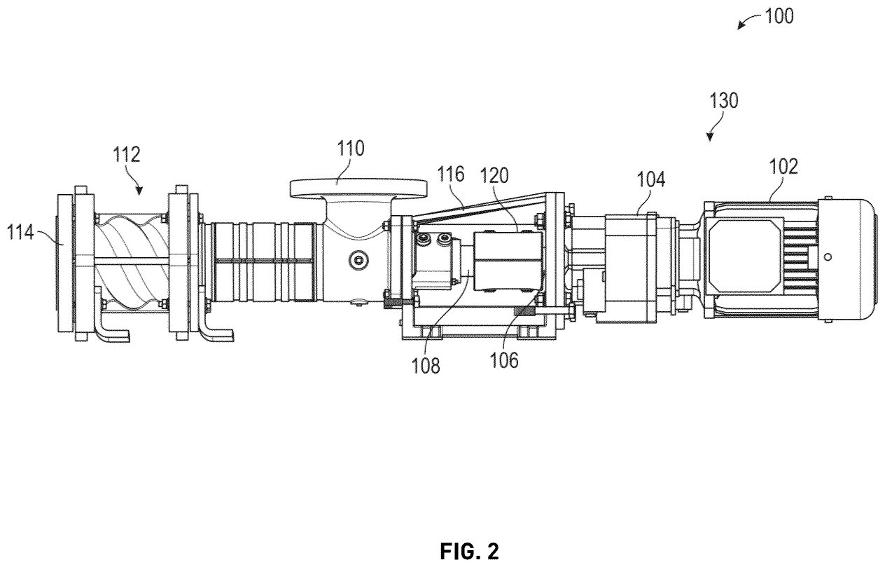

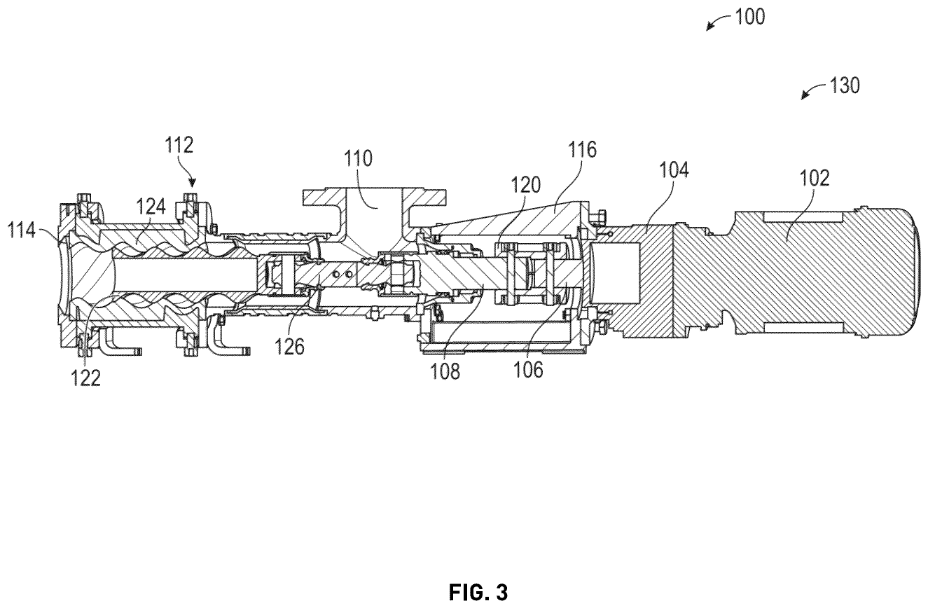

FIG. 1 through FIG. 3 show an example of portions of a progressive cavity pump system 100, and will be discussed together below. FIG. 1 shows a perspective view of an example of portions of a progressive cavity pump system 100. FIG. 2 shows a side view of the progressive cavity pump system 100 of FIG. 1. FIG. 3 shows a cross-sectional view of the progressive cavity pump system 100 of FIG. 1, where the cross section splits the progressive cavity pump system 100 vertically along a longitudinal axis. The progressive cavity pump system may be configured to pump fluids, slurries, sludges, or other flowable material. The progressive cavity pump system 100 can include a prime mover 130, a progressive cavity pump 112, a shaft coupling 120, and a housing 116.

The prime mover 130 can be configured to provide a motive force on the prime mover shaft 106, which can in turn provide a motive force to the progressive cavity pump 112 (e.g., through the shaft coupling 120). The prime mover 130 can include a motor 102 and a gearbox 104. The motor 102 can be coupled to the gearbox 104. The motor 102 can include an electric motor configured to generate rotational output power (e.g., torque) in a motor shaft from input electrical power. In an example, the motor 102 can be any form of power source, such as a combustion engine, a turbine engine, a hydraulic pump, etc. In an example, the prime mover 130 can include any device or system capable of providing a motive force to the progressive cavity pump 112, which can optionally include a gearbox 104 in addition to the motor 102.

The gearbox 104 can include a gearbox input shaft, which can be coupled to the motor shaft. The gearbox 104 can also include the prime mover shaft 106, which can be the output shaft of the gearbox 104. The gearbox 104 can change an angular velocity between the input shaft and the output shaft, change a mechanical advantage between the input shaft and the output shaft, or both. In an example, the gearbox 104 can decrease a rotational speed and increase a mechanical advantage between the input shaft and the output shaft.

With continued reference to FIGS. 1-3, the progressive cavity pump 112 of the system 100 may be described. The progressive cavity pump 112 may be configured to receive rotational power from the prime mover shaft 106 and pump and/or pressurize a flowable material using the rotational power operatively coupled to a positive displacement mechanism. More particularly, the progressive cavity pump 112 can include a fluid inlet 110, a fluid outlet 114, a power input shaft 108, a rotor 122, a stator 124, and a coupling rod 126.

The fluid inlet 110 can be arranged on a side of the progressive cavity pump 112. The fluid inlet 110 can receive the fluid to be pumped. The fluid inlet 110 can receive a fluid at a positive pressure (e.g., pre-pressurized), a negative pressure (e.g., suction head), or ambient pressure. The fluid outlet 114 can be arranged on the longitudinal end of the progressive cavity pump 112. The fluid outlet 114 can provide the pumped and/or pressurized fluid from the progressive cavity pump 112.

The rotor 122 can be configured to mesh with the stator 124. The rotor 122 and the stator 124 can be configured to generate a series of proceeding cavities when the rotor 122 is rotated within the stator 124. This series of proceeding cavities can move fluid from the fluid inlet 110 to the fluid outlet 114. The rotor 122 can include a helical shape (e.g., single helix (e.g., a single high lobe across 360 degrees at a specified cross section of the rotor 122), a double helix (e.g., two high lobes across 360 degrees)), and the stator 124 can include a corresponding helical shape, which can include a helical count that is one greater than the helical count of the rotor (e.g., a single helical rotor and a double helical stator (e.g., two indentations across 360 at a specified cross section of the stator 124), a double helical rotor and a triple helical stator). When the rotor 122 rotates within the stator 124, a center axis of the rotor 122 can move with respect to a center axis of the stator 124.

The coupling rod 126 can be configured to rotationally couple the rotor 122 to the power input shaft 108. The coupling rod 126 can be configured to accommodate an offset (e.g., a lateral offset in two parallel axes, an angular offset between two noncollinear axes) between an axis of the rotor 122 and an axis of the power input shaft 108. This can allow the axis of the power input shaft 108 to remain stationary with respect to an axis of the stator 124 while an axis of the rotor 122 moves with respect to an axis of the stator 124. The coupling rod 126 can include non-collinear couplings on one or both ends, which can allow the coupling rod 126 to be non-collinear with one or more of the rotor 122 or the power input shaft 108.

The housing 116 can be configured to be mounted to the prime mover 130, the progressive cavity pump 112, or both. The housing 116 may connect the prime mover 130 to the progressive cavity pump 112. The housing 116 can be a substantially rigid frame, which can result in the housing 116 holding the prime mover 130 and the progressive cavity pump 112 in a substantially consistent orientation. The prime mover shaft 106 can extend partially into (e.g., through) the housing 116. The power input shaft 108 can extend partially into the housing 116.

The shaft coupling 120 can be configured for coupling the prime mover shaft 106 to the power input shaft 108. The shaft coupling 120 can be positioned within the housing 116. The shaft coupling 120 can be positioned between the progressive cavity pump 112 and the prime mover 130.

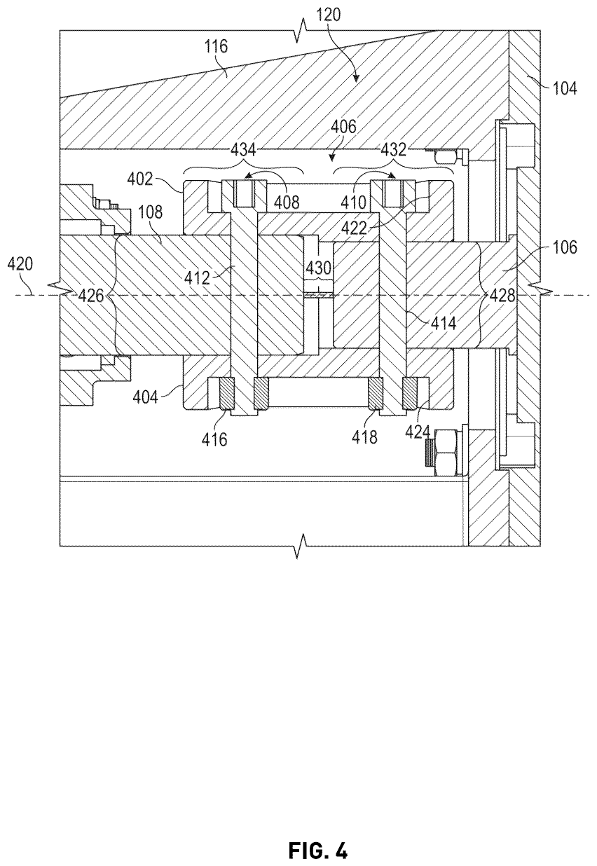

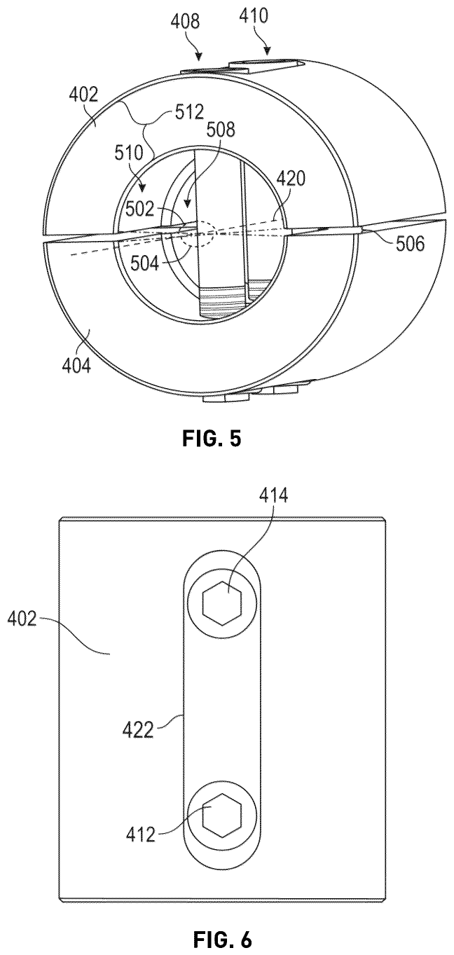

FIG. 4 shows a closer view of FIG. 3 including the shaft coupling 120. FIG. 5 shows a perspective view of the shaft coupling 120 looking from the direction of the progressive cavity pump 112 towards the prime mover 130. FIG. 4 and FIG. 5 will be discussed together below. The shaft coupling 120 can include a first half shell 402, a second half shell 404, and a fastening mechanism 406.

The shaft coupling 120 can be configured to transfer torque from the prime mover shaft 106 to the power input shaft 108. The fastening mechanism 406 can clamp, pinch, or squeeze the first half shell 402 towards the second half shell 404, which can clamp, pinch, or squeeze the prime mover shaft 106 and/or the power input shaft 108 between the first half shell 402 and the second half shell 404.

The first half shell 402 can be configured to transfer torque from the prime mover shaft 106 to the power input shaft 108, such as when the first half shell 402 is clamped to the second half shell 404 using the fastening mechanism 406. The first half shell 402 can include a shape that forms a sector (e.g., a radial sector) of a cylindrical shell. The first half shell 402 can include a first end 432 and a second end 434 along a longitudinal center axis 420. The first end 432 can include an inner contour 508, which can be configured to match an outer contour of the prime mover shaft 106. For example, the first end 432 can have an inner contour 508 that is substantially in the form of the inner surface of a cylinder, and the outer contour of the prime mover shaft 106 can have a substantially cylindrical shape. The diameter of the inner contour 508 can be configured to match an outer diameter 428 of the prime mover shaft 106. In an example, only a portion of the inner contour 508 can be configured to match the outer contour of the prime mover shaft 106. In an example, the prime mover shaft 106 might not be a cylindrical shaft (e.g., a square shaft, a hexagonal shaft, a cylindrical shaft including a flat face), and the inner contour 508 can be configured to match a portion of the outer contour of the prime mover shaft 106 (e.g., configured to match the non-cylindrical contour).

The second end 434 can include an inner contour 510, which can be configured to match an outer contour of the power input shaft 108. For example, the second end 434 can have an inner contour 510 that is substantially in the form of the inner surface of a cylinder, and the outer contour of the power input shaft 108 can have a substantially cylindrical shape. The diameter of the inner contour 510 can be configured to match an outer diameter 426 of the power input shaft 108. In an example, only a portion of the inner contour 510 can be configured to match the outer contour of the power input shaft 108. In an example, the prime mover shaft 106 might not be a cylindrical shaft (e.g., a square shaft, a hexagonal shaft, a cylindrical shaft including a flat face), and the inner contour 510 can be configured to match a portion of the outer contour of the power input shaft 108. The diameter 428 of the prime mover shaft can be different from the diameter 426 of the power input shaft, as shown in FIG. 4. This can result in the inner contour 510 having a greater diameter than the inner contour 508.

The outer surface of the first half shell 402 can be in the form of a cylindrical surface. In an example, the outer surface of the first half shell 402 can have any form, which can include the outer surface being a portion of a geometric prism, which can include one or more of a square prism, hexagonal prism, or octagonal prism. The first half shell 402 can have a specified radial thickness 512. The radial thickness 512 can be consistent throughout the first half shell 402, or can vary in one or more locations. The first half shell 402 can include a sector with a central angle 502.

The second half shell 404 can be configured to transfer a torque from the prime mover shaft 106 to the power input shaft 108, such as when the first half shell 402 is clamped to the second half shell 404 using the fastening mechanism 406. The second half shell 404 can be configured similarly to the first half shell 402, or can differ in one or more ways. The second half shell 404 can include a sector with a central angle 504. In an example, the central angle 502 and the central angle 504 can be the same. In an example, the central angle 502 and the central angle 504 can be different (e.g., the first half shell 402 and the second half shell 404 can be sectors of different sizes). In an example, one or both of the central angle 502, or the central angle 504 can include an angle that is less than 180 degrees, which can allow the first half shell 402, the second half shell 404, or both to fit over one or more of the power input shaft 108 or the prime mover shaft 106 radially. In an example, one or both of the central angle 502 or the central angle 504 can include an angle that is greater than 180 degrees, which can result in the first half shell 402, the second half shell 404, or both being slid over an end of the prime mover shaft 106, the power input shaft 108, or both. In an example, the sum of the central angle 502 and the central angle 504 is less than or equal to 360 degrees. In an example, the central angle 502, the central angle 504, or both can include a central angle that is greater than or equal to 170 degrees.

The fastening mechanism 406 can be configured to apply a force on the first half shell 402 and the second half shell 404 in a radially inward direction. This can include pulling the first half shell 402 towards the second half shell 404. The force can be applied through, and/or generally orthogonally across, the longitudinal center axis 420. For example, a line drawn from a location where a force is applied in the first half shell 402 to where a force, such as a corresponding force, is applied on the second half shell 404 can pass through or pass substantially through the longitudinal center axis 420. In one or more examples, this force may be generated by way of a fastener that extends through and/or generally orthogonally across the longitudinal center axis 420. Applying a force through the longitudinal center axis 420 can differ from applying one or more forces in which the resultant net force acts through the longitudinal center axis 420. For example, a first force can be applied at locations on the first half shell 402 and the second half shell 404 such that the first force does not act through the longitudinal center axis 420 (e.g., a line drawn from the location the first force is applied on the first half shell 402 to the location the first force is applied on the second half shell 404 does not pass through the longitudinal center axis 420). A second force can be applied at locations on the first half shell 402 and the second half shell 404 such that the second force does not act through the longitudinal center axis 420. However, one or more of the magnitude of the first force, the magnitude of the second force, the position the first force acts through, or the position the second force acts through, can be configured so that a sum of the first force and the second force (e.g., the resulting net force) acts through the longitudinal center axis 420 (e.g., the first force and the second force can be of equal magnitudes and act at the same distance from the longitudinal center axis 420, but on opposite lateral sides of the longitudinal center axis 420). This can include the net force acting through the longitudinal center axis 420 even though neither of the first force or the second force are applied through the longitudinal center axis 420.

The fastening mechanism 406 can include one or more fasteners, which can include a first fastener 408 and a second fastener 410. One or more of the one or more fasteners can be configured to apply a force on the first half shell 402, the second half shell 404, or both. This can include applying a radially inward force on the first half shell 402, the second half shell 404, or both. A portion or all of the force can be applied through the longitudinal center axis 420.

The fasteners can include any configuration of fastener, and can all be of one configuration, or can differ in configuration. The fasteners can include one or more of bolts, nuts, screws (e.g., machine screws, carriage bolts, lag bolts), clamps (e.g., hose clamps) U-bolts, or any other type of fastener or fastener component. One or more of the fasteners can be configured to apply a compression force that acts in a radially inward direction between a first end of the fastener and a second end of the fastener. The first end and the second end can be arranged along a longitudinal axis of the fastener. One or more of the fasteners (e.g., both the first fastener 408 and the second fastener 410, as shown in FIG. 5) can pass through the longitudinal center axis 420. This can include the longitudinal axis of the fastener passing substantially through the longitudinal center axis 420. FIG. 5 shows that the first fastener 408 and the second fastener 410 pass through the longitudinal center axis 420. Because the fasteners can apply a compression force along their longitudinal axis, and because the fasteners pass through the longitudinal center axis 420, the fasteners can apply a force through the longitudinal center axis 420. In an example, a compression style fastener (e.g., as shown in FIG. 5) may not be able to apply a force through the longitudinal center axis 420 if the longitudinal axis of the fastener does not pass through the longitudinal center axis 420.

In an example, the first fastener 408, the second fastener 410, or both, include a nut and a bolt. The first fastener 408 can include the first bolt 412 and the first nut 416. The second fastener 410 can include the second bolt 414 and the second nut 418. The respective nuts can be configured to thread onto the respective bolts. When the nut is turned in a tightening direction, a distance between the nut and a head of the bolt can be decreased, a force can be applied (e.g., increased) between the nut and the head of the bolt, or both.

The first fastener 408 can pass through the power input shaft 108. The power input shaft 108 can define a bore that is configured to receive the first fastener 408. The second fastener 410 can pass through the prime mover shaft 106. The prime mover shaft 106 can define a bore that is configured to receive the second fastener 410.

The heads of the bolts can be arranged in a first slot 422 in the first half shell 402. The first slot 422 can be configured so that the heads of the bolts have a substantially flat surface to seat on when they are tightened. The nuts can be arranged in a second slot 424 in the second half shell 404. The second slot 424 can be configured so that the nuts have a substantially flat surface to seat on when they are tightened.

In an example, the fastening mechanism 406 can include any number of fasteners (e.g., 1 fastener, 2 fasteners (e.g., as shown in FIG. 1-9), 3 fasteners, 4 fasteners, etc.). In an example, one or more of the fasteners can pass through the prime mover shaft 106, the power input shaft 108, or neither shaft (e.g., pass through the gap 430).

The shaft coupling 120 can be configured so that a frictional force between the half shells, the prime mover shaft 106, and the power input shaft 108 transfers a torque between the prime mover shaft 106 and the power input shaft 108. For example, the fastening mechanism 406 can provide a radially inward force, which can result in the half shells being pressed against the power input shaft 108, the prime mover shaft 106, or both. The force of the respective half shells pressing against the shafts can generate a frictional force (e.g., a “force” that acts to resist the relative motion of the half shells and the shafts). Increasing a force applied by the fastening mechanism 406 can increase a frictional force, such as in a substantially linear relation.

In an example, the shaft coupling 120 can be configured so that there is little to no, or at least limited, shear force in the first fastener 408 and the second fastener 410. For example, a force applied by the first fastener 408, the second fastener 410, or both (e.g., due to a torque level of the fasteners) can be configured so that the frictional forces between the half shells and the respective shafts exceed a maximum force applied due to a torque in the shafts (e.g., a maximum torque that can be applied by the prime mover 130). This can result in the half shells remaining stationary with respect to the shafts (e.g., due to the frictional force exceeding any outside forces), which can prevent a shear force from being applied to the fasteners.

In an example, when the shaft coupling 120 is in a fully engaged configuration (e.g., the fastening mechanism is applying a specified amount of force, which can include the fasteners being torqued to a specified torque setting), there can be a longitudinal gap 430 between the power input shaft 108 and the prime mover shaft 106. This can allow one or more components (e.g., seal components) to be removed and installed through the gap 430 by removing the shaft coupling 120. This can include removing or installing components through the gap 430 while the prime mover 130 and the progressive cavity pump 112 remain mounted to the housing 116.

In an example, when the shaft coupling 120 is in a fully engaged configuration, there can be a gap 506 between the first half shell 402 and the second half shell 404. This gap 506 can help to allow the force applied by the fastening mechanism 406 to be exerted by the half shells on the shafts, as opposed to being exerted by one half shell on the other half shell.

FIG. 6 shows a top view of a shaft coupling 120. The top of the shaft coupling 120 can be defined as the side that the first half shell 402 can be arranged on the shafts. FIG. 6 shows the heads of the second bolt 414 and the first bolt 412 can be arranged (e.g., received) in a first slot 422 in the first half shell 402. The first slot 422 can be large enough that the heads of the bolts can be accessed by tools (e.g., a socket) and rotated within the first slot 422.

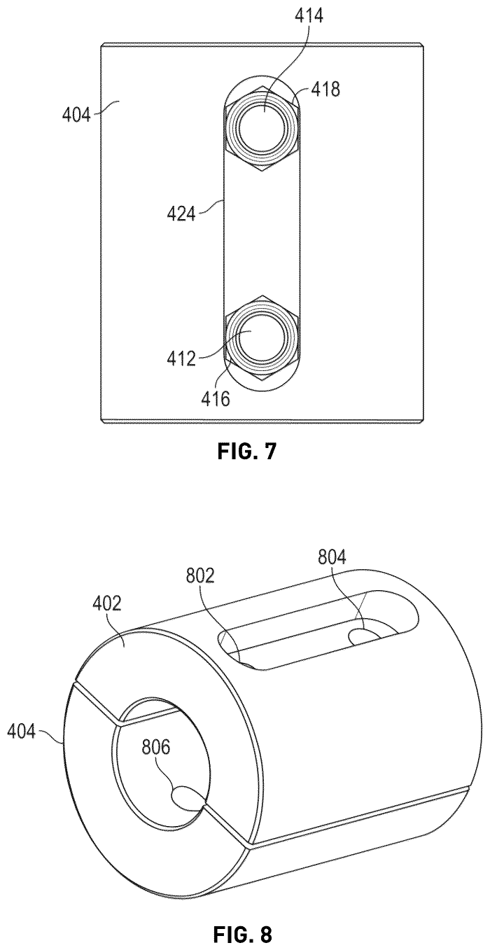

FIG. 7 shows a bottom view of a shaft coupling 120. The bottom of the shaft coupling 120 can be defined as the side opposite the top, which can include the side that the second half shell 404 can be arranged on the shafts. FIG. 7 shows that the first nut 416 and the second nut can be arranged in the second slot 424 in the second half shell 404. The second slot 424 can be configured to impinge on an outer surface of the nuts to prevent the nuts from rotating. For example, the second slot 424 can be sized so that one or more faces of the nuts impinge on the walls of the second slot 424 (e.g., as shown in FIG. 7), which can act to prevent the nut from rotating. This can allow the bolts to be tightened without requiring the nuts to be held in place using an additional tool.

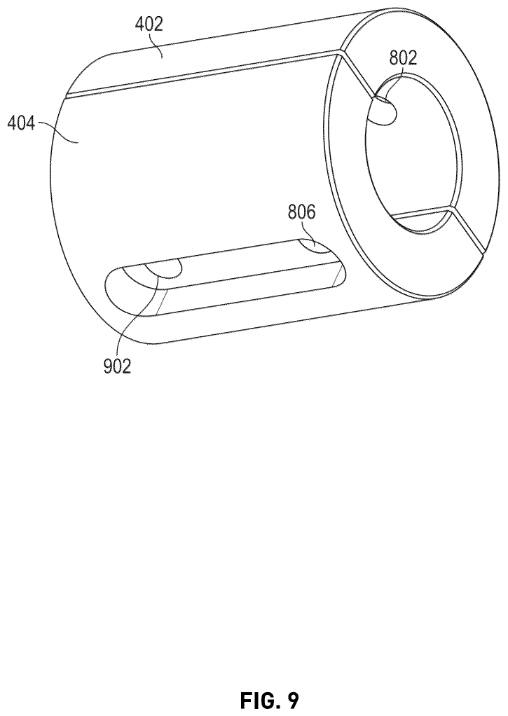

FIG. 8 and FIG. 9 show perspective views of a shaft coupling 120, such as with the fastening mechanism 406 removed. FIG. 8 shows that the first half shell 402 can define a first aperture 802, which can receive the first bolt 412. The first half shell 402 can also define a second aperture 804, which can receive the second bolt 414. The second half shell 404 can include a third aperture 806, which can receive the first bolt 412. FIG. 9 shows that the second half shell 404 can include a fourth aperture 902, which can receive the second bolt 414.

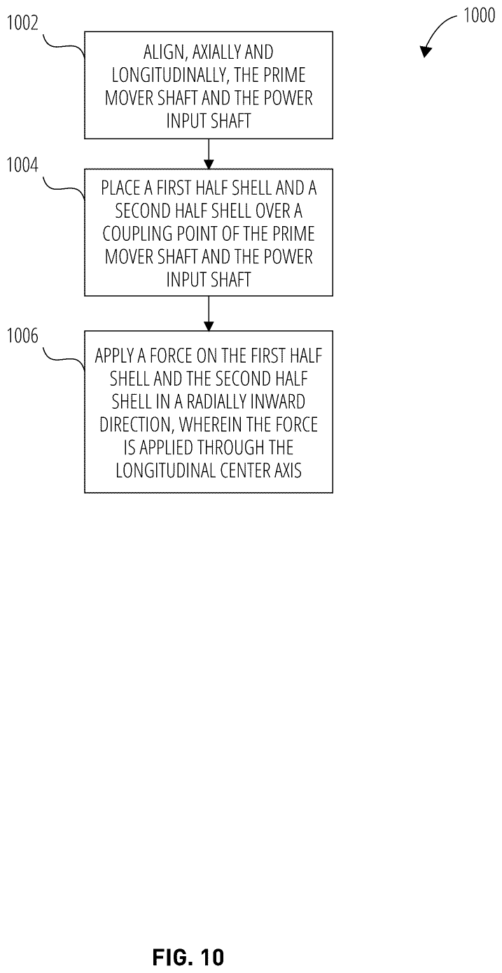

FIG. 10 shows an example of portions of a method 1000 for coupling shafts, such as using the shaft coupling 120. The method 1000 can include a method for coupling a prime mover shaft (e.g., the prime mover shaft 106) to a power input shaft (e.g., the power input shaft 108) of a progressive cavity pump. At step 1002, the prime mover shaft and the power input shaft can be aligned axially (e.g., aligning a center axis of the prime mover shaft with a center axis of the power input shaft so that they are parallel, so that they intersect, or both (e.g., are colinear), longitudinally (e.g., providing a specified spacing between the prime mover shaft and the power input shaft, which can generate the gap 430), or both.

At step 1004, a first half shell (e.g., the first half shell 402) and a second half shell (e.g., the second half shell 404) can be placed over a coupling point of the prime mover shaft and the power input shaft. The coupling point can include a location at which the shafts meet or are nearest. The first half shell and the second half shell can be held temporarily in place following step 1004.

In an example, each of the half shells can include a first end and a second end along a longitudinal center axis. The first end can include an inner contour that can be configured to match an outer contour of the prime mover shaft. The second end can include an inner contour that can be configured to match an outer contour of the power input shaft. One or more of the half shells can include a sector of a cylindrical shell.

At step 1006, a force can be applied on the first half shell and the second half shell in a radially inward direction. The force can be applied through the longitudinal center axis (e.g., the longitudinal center axis 420). The force can be applied using a fastening mechanism, such as the fastening mechanism 406. Applying the force can include tightening the fastening mechanism, which can include tightening one or more fasteners in the fastening mechanism.

In an example, force that is sufficiently large so that a frictional force between the half shells, the prime mover shaft, and the power input shaft is greater than a force that is generated by a torque in the prime mover shaft and the power input shaft can be applied. This can include calculating one or more of the torque in the prime mover shaft (e.g., the maximum torque that can be generated), calculating a frictional force that can exceed the torque, calculating a clamping force of the fastening mechanism that can generate the frictional force, or calculating another value (e.g., a fastener torque setting) that can cause the fastening mechanism to apply the force.

The shown order of steps is not intended to be a limitation on the order in which the steps are performed. In an example, two or more steps may be performed simultaneously or at least partially concurrently.

The following, non-limiting examples, detail certain aspects of the present subject matter to solve the challenges and provide the benefits discussed herein, among others.

### EXAMPLES

Example 1 is a shaft coupling for coupling a prime mover shaft to a power input shaft of a progressive cavity pump, the shaft coupling comprising: a first half shell and a second half shell, each of the half shells including: a first end and a second end along a longitudinal center axis, the first end including an inner contour configured to match an outer contour of the prime mover shaft and the second end including an inner contour configured to match an outer contour of the power input shaft; and a fastening mechanism, configured for applying a force on the first half shell and the second half shell in a radially inward direction, wherein the force is applied through the longitudinal center axis.

In Example 2, the subject matter of Example 1 optionally includes wherein the fastening mechanism includes a first fastener and a second fastener, wherein the first fastener and the second fastener pass through the longitudinal center axis.

In Example 3, the subject matter of Example 2 optionally includes wherein the first fastener passes through the prime mover shaft and the second fastener passes through the power input shaft.

In Example 4, the subject matter of Example 3 optionally includes wherein the shaft coupling is configured so that a frictional force between the half shells, the prime mover shaft, and the power input shaft transfers a torque between the prime mover shaft and the power input shaft.

In Example 5, the subject matter of Example 4 optionally includes wherein the shaft coupling is configured so that there is no shear force in the first fastener and the second fastener.

In Example 6, the subject matter of any one or more of Examples 2-5 optionally include wherein both the first fastener and the second fastener include a nut and a bolt.

In Example 7, the subject matter of Example 6 optionally includes a first slot in the first half shell, configured to receive a head of the bolts; and a second slot in the second half shell, configured to receive the nuts.

In Example 8, the subject matter of Example 7 optionally includes wherein the second slot is configured to impinge on an outer surface of the nuts to prevent the nuts from rotating.

In Example 9, the subject matter of any one or more of Examples 1-8 optionally include wherein an outer diameter of the prime mover shaft is different from the outer diameter of the power input shaft.

In Example 10, the subject matter of any one or more of Examples 1-9 optionally include wherein each of the half shells include a sector of a cylindrical shell.

In Example 11, the subject matter of Example 10 optionally includes wherein the first half shell and the second half shell include a sector with a same central angle, wherein the central angle is greater than or equal to 170 degrees.

In Example 12, the subject matter of any one or more of Examples 1-11 optionally include wherein when the shaft coupling is in a fully engaged configuration, there is a gap between the first half shell and the second half shell.

In Example 13, the subject matter of any one or more of Examples 1-12 optionally include wherein when the shaft coupling is in a fully engaged configuration, there is a longitudinal gap between the prime mover shaft and the power input shaft.

Example 14 is a method of coupling a prime mover shaft to a power input shaft of a progressive cavity pump, the method comprising: aligning, axially and longitudinally, the prime mover shaft and the power input shaft; placing a first half shell and a second half shell over a coupling point of the prime mover shaft and the power input shaft, each of the half shells including: a first end and a second end along a longitudinal center axis, the first end including an inner contour configured to match an outer contour of the prime mover shaft and the second end including an inner contour configured to match an outer contour of the power input shaft; and applying a force on the first half shell and the second half shell in a radially inward direction, wherein the force is applied through the longitudinal center axis.

In Example 15, the subject matter of Example 14 optionally includes applying a force that is sufficiently large so that a frictional force between the half shells, the prime mover shaft, and the power input shaft is greater than a force that is generated by a torque in the prime mover shaft and the power input shaft.

In Example 16, the subject matter of any one or more of Examples 14-15 optionally include wherein each of the half shells include a sector of a cylindrical shell.

Example 17 is a progressive cavity pump system, comprising: a prime mover including a prime mover shaft; a progressive cavity pump, including a power input shaft; and a shaft coupling for coupling the prime mover shaft to the power input shaft, the shaft coupling comprising: a first half shell and a second half shell, each of the half shells including: a first end and a second end along a longitudinal center axis, the first end including an inner contour configured to match an outer contour of the prime mover shaft and the second end including an inner contour configured to match an outer contour of the power input shaft; and a fastening mechanism, configured for applying a force on the first half shell and the second half shell in a radially inward direction, wherein the force is applied through the longitudinal center axis.

In Example 18, the subject matter of Example 17 optionally includes wherein the progressive cavity pump system comprises: a housing, configured to mount the progressive cavity pump to the prime mover, wherein: the prime mover shaft extends partially through the housing; and the power input shaft extends partially through the housing.

In Example 19, the subject matter of any one or more of Examples 17-18 optionally include wherein the fastening mechanism includes a first fastener and a second fastener, wherein the first fastener and the second fastener pass through the longitudinal center axis, wherein the first fastener passes through the prime mover shaft and the second fastener passes through the power input shaft.

In Example 20, the subject matter of any one or more of Examples 17-19 optionally include wherein each of the half shells include a sector of a cylindrical shell.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A shaft coupling for coupling a prime mover shaft to a power input shaft of a progressive cavity pump, the shaft coupling comprising:
a first half shell and a second half shell, each of the half shells including:
a first end and a second end along a longitudinal center axis, the first end including an inner contour configured to match an outer contour of the prime mover shaft and the second end including an inner contour configured to match an outer contour of the power input shaft; and
a fastening mechanism, configured for applying a force on the first half shell and the second half shell in a radially inward direction, wherein the force is applied through the longitudinal center axis.

2. The shaft coupling of claim 1, wherein the fastening mechanism includes a first fastener and a second fastener, wherein the first fastener and the second fastener pass through the longitudinal center axis.

3. The shaft coupling of claim 2, wherein the first fastener passes through the prime mover shaft and the second fastener passes through the power input shaft.

4. The shaft coupling of claim 3, wherein the shaft coupling is configured so that a frictional force between the half shells, the prime mover shaft, and the power input shaft transfers a torque between the prime mover shaft and the power input shaft.

5. The shaft coupling of claim 4, wherein the shaft coupling is configured so that there is no shear force in the first fastener and the second fastener.

6. The shaft coupling of claim 2, wherein both the first fastener and the second fastener include a nut and a bolt.

7. The shaft coupling of claim 6, comprising:
a first slot in the first half shell, configured to receive a head of the bolts; and
a second slot in the second half shell, configured to receive the nuts.

8. The shaft coupling of claim 7, wherein the second slot is configured to impinge on an outer surface of the nuts to prevent the nuts from rotating.

9. The shaft coupling of claim 1, wherein an outer diameter of the prime mover shaft is different from the outer diameter of the power input shaft.

10. The shaft coupling of claim 1, wherein each of the half shells include a sector of a cylindrical shell.

11. The shaft coupling of claim 10, wherein the first half shell and the second half shell include a sector with a same central angle, wherein the central angle is greater than or equal to 170 degrees.

12. The shaft coupling of claim 1, wherein when the shaft coupling is in a fully engaged configuration, there is a gap between the first half shell and the second half shell.

13. The shaft coupling of claim 1, wherein when the shaft coupling is in a fully engaged configuration, there is a longitudinal gap between the prime mover shaft and the power input shaft.

14. A method of coupling a prime mover shaft to a power input shaft of a progressive cavity pump, the method comprising:
aligning, axially and longitudinally, the prime mover shaft and the power input shaft;
placing a first half shell and a second half shell over a coupling point of the prime mover shaft and the power input shaft, each of the half shells including:
a first end and a second end along a longitudinal center axis, the first end including an inner contour configured to match an outer contour of the prime mover shaft and the second end including an inner contour configured to match an outer contour of the power input shaft; and
applying a force on the first half shell and the second half shell in a radially inward direction, wherein the force is applied through the longitudinal center axis.

15. The method of claim 14, comprising:
applying a force that is sufficiently large so that a frictional force between the half shells, the prime mover shaft, and the power input shaft is greater than a force that is generated by a torque in the prime mover shaft and the power input shaft.

16. The method of claim 14, wherein each of the half shells include a sector of a cylindrical shell.

17. A progressive cavity pump system, comprising:
a prime mover including a prime mover shaft;
a progressive cavity pump, including a power input shaft; and
a shaft coupling for coupling the prime mover shaft to the power input shaft, the shaft coupling comprising:
a first half shell and a second half shell, each of the half shells including:
a first end and a second end along a longitudinal center axis, the first end including an inner contour configured to match an outer contour of the prime mover shaft and the second end including an inner contour configured to match an outer contour of the power input shaft; and
a fastening mechanism, configured for applying a force on the first half shell and the second half shell in a radially inward direction, wherein the force is applied through the longitudinal center axis.

18. The progressive cavity pump system of claim 17, wherein the progressive cavity pump system comprises:
a housing, configured to mount the progressive cavity pump to the prime mover, wherein:
the prime mover shaft extends partially through the housing; and
the power input shaft extends partially through the housing.

19. The progressive cavity pump system of claim 17, wherein the fastening mechanism includes a first fastener and a second fastener, wherein the first fastener and the second fastener pass through the longitudinal center axis, wherein the first fastener passes through the prime mover shaft and the second fastener passes through the power input shaft.

20. The progressive cavity pump system of claim 17, wherein each of the half shells include a sector of a cylindrical shell.
